(19) United States
(12) Patent Application Publication
(10) Pub. No.: US 2005/0175789 A1
(43) Pub. Date: Aug. 11, 2005

(54) Method for energy-assisted atomic layer deposition and removal

(76) Inventors: Aubrey L Helms Jr, Los Gatos, CA (US); Kerem Kapkin, Watsonville, CA (US); Sang-In Lee, Cupertino, CA (US); Yoshihide Senzaki, Austin, TX (US)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 10/519,331

(22) PCT Filed: Jun. 23, 2003
(86) PCT No.: PCT/US03/19984

Related U.S. Application Data
(60) Provisional application No. 60/391,012, filed on Jun. 23, 2002.
(60) Provisional application No. 60/396,743, filed on Jul. 19, 2002.

(51) Int. Cl. G21H 1/00; H01F 41/00

(52) U.S. Cl. 427/457; 427/585

(57) ABSTRACT

A method for energy-assisted atomic layer deposition and removal of a dielectric film are provided. In one embodiment a substrate is placed into a reaction chamber and a gaseous precursor is introduced into the reaction chamber. Energy is provide by a pulse of electromagnetic radiation which forms radical species of the gaseous precursor. The radical species react with the surface of the substrate to form a radical terminated surface on the substrate. The reaction chamber is purged and a second gaseous precursor is introduced. A second electromagnetic radiation pulse is initiated and forms second radical species. The second radical species of the second gas react with the surface to form a film on the substrate. Alternately, the gaseous species can be chosen to produce radicals that result in the removal of material from the surface of the substrate.

### RELATED APPLICATIONS

This application claims priority to and the benefit of U.S. Provisional Application Ser. No. 60/391,012, filed on Jun. 23, 2002 and U.S. Provisional Application Ser. No. 60/396,743, filed on Jul. 19, 2002, the disclosures of both are hereby incorporated by reference in its entirety.

### FIELD OF THE INVENTION

The present invention relates generally to the field of semiconductors. More specifically, the present invention relates to energy-assisted atomic layer deposition and removal of films on semiconductor devices and wafers.

### BACKGROUND OF THE INVENTION

Semiconductor devices of future generation require thin dielectric films for metal oxide silicon (MOS) transistor gates, and capacitor dielectrics. As oxide films are scaled down, the tunneling leakage current becomes significant and limits the useful range for gate oxides to about 1.8 nm or more.

High dielectric constant (“high-k”) metal oxides have been considered as possible alternative materials to silicon oxide (having a dielectric constant k of about 3.9) to provide gate dielectrics with high capacitance but without compromising the leakage current. Metal oxides such as hafnium oxide (HfO₂) having a dielectric constant of about 20, zirconium oxide (ZrO₂) having a dielectric constant of about 20, and Hf and Zr silicates have been reported. However, prior art fabrication techniques such as chemical vapor deposition (CVD) are increasingly unable to meet the requirements of forming these advanced thin films. While CVD processes can be tailored to provide conformal films with improved step coverage, CVD processes often require high processing temperatures, result in incorporation of high impurity concentrations, and have poor precursor or reactant utilization efficiency. For instance, one of the obstacles in fabricating high-k gate dielectrics is the formation of an interfacial silicon oxide layer during CVD processing as illustrated in FIG. 1. Interfacial oxide growth problems for gate and capacitor dielectric application have been widely reported in the industry. This problem has become one of the major hurdles for implementing high-k materials in advanced device fabrication. Another obstacle is the limitation of prior art CVD processes in depositing ultra thin (typically 10 Å or less) films for high-k gate dielectrics on a silicon substrate.

Atomic layer deposition (ALD) is an alternative to traditional CVD processes to deposit very thin films. ALD has several advantages over traditional CVD techniques. ALD can be performed at comparatively lower temperatures which is compatible with the industry's trend toward lower temperatures, has high precursor utilization efficiency, and can produce conformal thin film layers. More advantageously, ALD can control film thickness on an atomic scale, and can be used to “nano-engineer” complex thin films. Accordingly, further developments in ALD are highly desirable, particularly development of a process carried out at room temperature, or near room temperature, as this method would provide the benefits of ALD without the drawbacks of interfacial oxide growth.

### SUMMARY OF THE INVENTION

The present invention provides a method and system of forming films on semiconductor devices and wafers by energy-assisted atomic layer deposition (EALD) and removal. Additionally the present invention provides a method of depositing a metal containing film on a substrate without forming an interfacial oxide layer between the metal containing film and the substrate.

In one aspect of the invention, there is provided a method of energy-assisted atomic layer deposition of a film on a substrate. According to the EALD method of the invention, a substrate is placed in a reaction chamber suitable for carrying out the method. Optionally, the substrate may first be pre-treated to condition the surface of the substrate. A first gaseous precursor is introduced into the reactor about the substrate. Energy assistance is provided by exposing the gas and substrate to first pulse of electromagnetic irradiation such that radical species from the gas are formed. Examples of suitable electromagnetic radiation include, but are not limited to, visible light radiation, infrared radiation, ultraviolet radiation, microwave radiation, radio frequency radiation, and the like. In another embodiment, radiation with high energy such as “vacuum ultraviolet (VUV) radiation” is employed to initiate the desired chemical reactions at or near room temperature. It will be clear to one of ordinary skill in the art that the amount of energy of the electromagnetic radiation is selected using routine experimentation so as to most advantageously initiate the desired reaction. The radiation may be supplied in a coherent form from a device such as a laser, or in a non-coherent (i.e. out of phase) form from a device such as a lamp.

The use of electromagnetic radiation facilitates the reaction of the first reactant gas with the stable surface. The radical species react with the surface to terminate the surface with the radical species. The excess first gaseous precursor and radical species are removed from the reaction chamber by evacuating with a vacuum pump, purging with an inert gas, or both. Then a second precursor is introduced into the reaction chamber and a second pulse of electromagnetic irradiation is initiated to form radicals from the second precursor. The radical species from the second precursor react with the terminated surface to form an atomic layer of material on the surface of the substrate. The excess second gaseous precursor and radical species are removed from the reaction chamber by evacuating with a vacuum pump, purging with an inert gas, or both. This sequence is repeated as many times as necessary to deposit a film of the desired thickness on the substrate.

In another aspect, the present invention provides a method and system of forming films on semiconductor devices and wafers by atomic layer deposition at or near room temperature. Room temperature may vary but is generally defined as in the range of approximately 20 to 30° C. In this embodiment, deposition is carried out in a reaction chamber in a vacuum environment and the substrate is exposed to UV energy. More specifically, a vacuum UV (VUV) assisted atomic layer deposition process is carried out at a low temperature to deposit a film on the surface of the substrate. A reactant gas or set of gasses is introduced into a vacuum chamber to react with a first layer of the film to convert the first layer into a mono-layer of a solid compound. Optionally, an oxidant gas is introduced in combination with reactant gas. Excess reactant gas is then purged from the chamber. The surface of the substrate is subjected to VUV radiation. Excess gas is again purged from the chamber. The cycle is repeated as necessary using the same or different reactant gases.

### BRIEF DESCRIPTION OF THE FIGURES

The foregoing and other objects of the invention will be more clearly understood from the following description when read in conjunction with the accompanying drawings in which:

FIG. 1 is a schematic view illustrating an interfacial silicon oxide layer formed between a metal containing layer and silicon substrate during a prior art deposition process.

FIG. 2 is a schematic view illustrating a reactor for carrying out the atomic layer deposition method according to one embodiment of the present invention.

FIGS. 3A to 3J are schematic diagrams illustrating the steps of atomic layer exchange for formation of a gate dielectric exhibiting an equivalent oxide thickness (EOT) of approximately 5 according to another embodiment of the present invention.

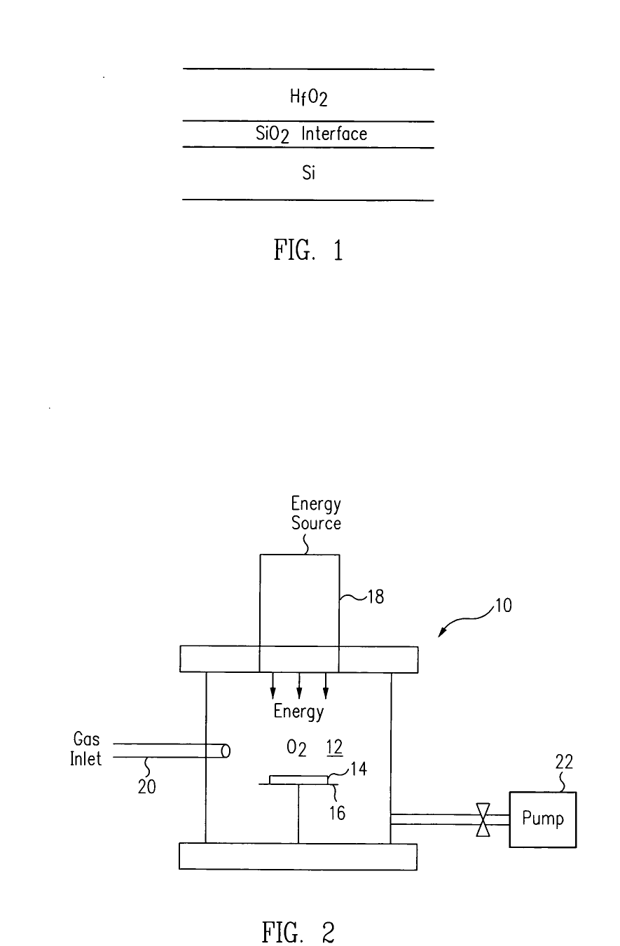

### DETAILED DESCRIPTION OF THE INVENTION

In general, the present invention provides a method and system of forming films on semiconductor devices and wafers by energy-assisted atomic layer deposition and removal. More specifically, in one embodiment of the present invention, a method of atomic layer deposition of a film on a substrate is provided. In general, the method of the present invention is comprised of the following steps: a substrate is placed in a reaction chamber. The substrate may be a bare silicon substrate, or alternatively may have a film deposited on the surface of the substrate. Optionally, the substrate may be pre-treated to condition the surface of the substrate. Pre-treatment may be employed to clean and/or activate the surface of the substrate.

A first gaseous precursor is introduced into the reaction chamber about the surface of the substrate. To initiate a desired chemical reaction with the film on the surface of the substrate, energy is employed. Specifically, the gaseous precursor and substrate are exposed to a first pulse of electromagnetic irradiation such that radical species of the gaseous precursor are formed. The electromagnetic radiation facilitates the reaction of the first gaseous precursor with the stable surface. The radical species of the gaseous precursor react with the surface to terminate the surface with the radical species. The excess first gaseous precursors and radical species are removed from the reaction chamber by evacuating with a vacuum pump, purging with an inert gas, or both. Next, a second precursor is introduced into the reaction chamber and a second pulse of electromagnetic irradiation is initiated to form radical species from the second precursor. These second radical species react with the terminated surface to form an atomic layer of material on the surface of the substrate. The excess second gaseous precursor and radical species are removed from the reaction chamber by evacuating with a vacuum pump, purging with an inert gas, or both. This sequence is repeated as many times as necessary to deposit a film of the desired thickness.

Many forms of electromagnetic radiation may be used in the present invention. Examples of suitable sources of electromagnetic radiation include, but are not limited to, visible light radiation, infrared radiation, ultraviolet radiation, microwave radiation, radio frequency radiation, and the like. In another embodiment, electromagnetic radiation with high energy such as “vacuum ultraviolet (VUV) radiation” is employed to initiate chemical reactions at or near room temperature. In one embodiment, VUV radiation is at wavelengths in the range of approximately 100 to 200 nm. It will be clear to one of ordinary skill in the art that the energy of the electromagnetic radiation can be chosen so as to most advantageously initiate the desired reaction by routine experimentation. The radiation may be supplied in a coherent form from a device such as a laser, or in a non-coherent (i.e. out of phase) form from a device such as a lamp.

In general, the method of the present invention may be carried out at a relatively low temperature. In one embodiment atomic layer deposition is carried out at a temperature of less than approximately 500° C. In another embodiment, the method of the present invention is carried out at a temperature in the range of approximately 20 to 400° C. In yet another embodiment, the atomic layer deposition process is carried out at a temperature in the range of approximately 100 to 200° C.

Preferably, the atomic layer deposition method of the present invention is carried out at low pressure. In one embodiment the deposition and energy pulse steps of the method are carried out at a pressure in the range of approximately 1 mTorr to 760 Torr. More typically the pressure is in the range of less than approximately 150 Torr. In another embodiment, the pressure is in the range of less than approximately 15 Torr. During evacuation of the reaction chamber, the pressure may vary from these ranges.

In one embodiment where the method is carried out using vacuum ultraviolet radiation (VUV), the pressure within the reaction chamber is maintained under vacuum, less than approximately 15 Torr, and preferably less than approximately 1 Torr; and the deposition process is carried out at a temperature in the range of approximately 20 to 30° C.

The present invention is further described with reference to FIG. 2 which schematically illustrates a typical reactor that can be employed to perform the method of the present invention. While a specific reactor is shown for illustrative purpose, other reactor designs and configurations may be used and the present method is not limited to any one reactor or reaction chamber design. The method can be performed in any suitable reactor having an energy source.

FIG. 2 shows a simplified reactor 10 comprising in general a reaction chamber 12 which houses a semiconductor substrate 14 supported on a wafer support 16. An energy source 18 is provided which couples electromagnetic radiation to the reaction chamber 12. Gaseous precursors are conveyed to the reaction chamber 12 via one or more gas inlets 20. The reaction chamber 12 is evacuated by a pump 22 coupled to the reaction chamber 12.

The chamber is configured so that reactant (precursor) gasses can be introduced and purged from the chamber. In one embodiment the gas inlet 20 may be comprised of a gas injector, such as a showerhead injector. Alternatively the gas inlet 20 may be comprised of single or dual annular ring(s) with a plurality of nozzles. Other suitable types of gas inlets may be employed, such as a single point inlet as depicted in FIG. 2. When a reactant is available in liquid form, a bubbler or other vaporizer system (not shown) may be used to provide the reactant in gaseous form.

Energy is provided to the reaction chamber by the energy source 18. The energy source 18 may take the form of visible light, infrared, ultraviolet, microwave, or radio frequency radiation sources, among others. In one embodiment an ultraviolet radiation source such as a Xe excimer lamp, may be used. The Xe excimer lamp is suitable for large area irradiation and thus is particularly useful. The Xe excimer lamp irradiates at a wavelength of 172 nm. Other UV sources suitable for large area irradiation may be used, for instance those sufficient to illuminate the entire surface of the substrate. Different types of lamps provide different wavelengths and correspondingly will deliver different photon energies. Irradiation at wavelengths less than 200 nm may be desirable depending on the particular application and the amount of photon energy required. The exact wavelength for a given application may be determined by those of ordinary skill in the art using routine experimentation. During processing, the energy source may be pulsed on and off, or a shutter (not shown) may be positioned adjacent the energy source which is opened and closed to permit coupling of energy into the reaction chamber as appropriate.

The method of the present invention is now described in greater detail. In an illustrative example, a substrate having an oxide film deposited on the surface of the substrate is pre-treated to form a hydrogen-terminated surface. The hydrogen-terminated surface is known to be stable for a certain period of time. The substrate having a hydrogen-terminated surface is then placed in the reaction chamber. Preferably the reaction chamber is maintained at a low temperature and high vacuum, examples of the ranges of these variable being recited above. An oxygen containing gas is introduced into the reaction chamber, preferably the gas is injected in the area above the substrate, and a first pulse of electromagnetic irradiation is initiated which disassociates the oxygen containing gas to form oxygen. The oxygen radicals react with hydrogen at the silicon surface. An oxygen terminated surface is formed by atomic layer exchange between the hydrogen and oxygen. A method of atomic layer exchange is further described in co-pending PCT patent application Ser. no. ______ (Attorney Docket A-71606/MSS), filed simultaneously herewith and claiming the benefit of U.S. provisional patent application Ser. No. 60/391,011 filed Jun. 23, 2002, the disclosures of both being herein expressly incorporated by reference.

The reaction chamber is purged to remove the excess reactants and any by-products of the reaction. A metal precursor is introduced into the reaction chamber and a second pulseof electromagnetic irradiation is initiated to disassociate the metal precursor molecules and form metal radicals. The metal radicals react with the oxygen terminated surface to form an atomic layer of metal oxide on the surface of the substrate.

In the illustrative example where the substrate has an oxide deposited on the surface of the substrate, the following structure is present:

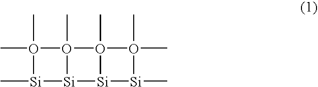

For pretreatment, the substrate having oxides deposited on the surface is dipped in a weak hydrogen fluoride (HF) solution to create a hydrogen-terminated surface as shown in the following structure:

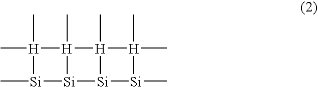

The substrate having the hydrogen-terminated surface is then placed in a reactor which is maintained at a low temperature and high vacuum. An oxygen containing gas is introduced into the reactor above the substrate. Examples of the oxygen containing gas include (but not limited to) O₃, O₂, NO, N₂O, H₂O, H₂O₂, and the like. The oxygen containing gas can be introduced into the reactor in various ways and is delivered about the substrate. For example, the oxygen containing gas can be introduced into the reactor from the top or the sidewall of the reactor. The hydrogen-terminated surface is exposed to the oxygen containing gas. However, the oxygen containing gas does not react with the hydrogen at the substrate surface due to the low temperature and pressure maintained in the reactor.

To activate the reaction, a first pulse of electromagnetic irradiation is initiated which activates the oxygen containing gas above the surface of the substrate to form oxygen radicals. Any form of electromagnetic irradiation can be used, and preferably the electromagnetic irradiation is pulsed. Examples of this electromagnetic radiation include, but are not limited to, visible light radiation, infrared radiation, ultraviolet radiation, microwave radiation, radio frequency radiation, and the like. The radiation may be supplied in a coherent form from a device such as a laser, or in an incoherent manner from a device such as a lamp. The selection of electromagnetic irradiation depends on the application and the type of film to be deposited. While microwave energy, radio frequency radiation and the like may create an electrical field across the substrate, visible, infrared, and ultraviolet radiation and the like do not create an electrical field and thus are preferable for applications where electrical fields should be avoided. The electromagnetic irradiation can emanate from the top of the reactor, or may be focused to a particular localized region or area on the substrate. Alternatively, in a multiple wafer reactor, a side wall scanning radiation source can be used to sequentially expose multiple substrates to the electromagnetic radiation pulses. Alternately, a focused source of electromagnetic radiation can be used to activate the reaction on selected areas of the substrate, creating a direct write process.

In the exemplary embodiment, the oxygen radicals formed react with hydrogen at the silicon surface to undergo atomic exchange, resulting in an oxygen terminated surface, as illustrated in the following equation:

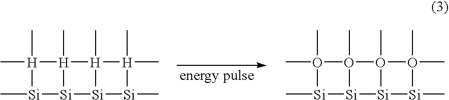

A metal containing compound such as hafnium chloride (HfCl₄), TEMA-Hf, Hf(t-BuO)₄, and the like, is introduced into the reactor and a second pulse of electromagnetic irradiation is initiated to disassociate the molecules of the metal containing compound forming metal radicals. The selection of electromagnetic irradiation depends on how much energy is needed to disassociate the molecule of the metal containing compound and may be determined by one of ordinary skill in the art using routine experimentation.

The metal radicals then react with the oxygen at the oxygen terminated surface to form an atomic metal oxide layer on the surface of the substrate, as illustrated in the following equation:

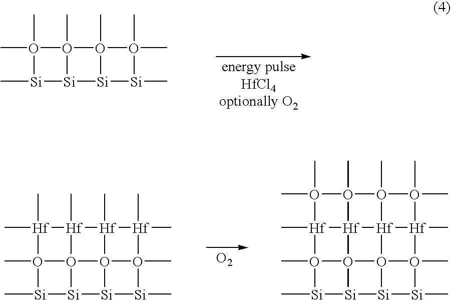

As illustrated, a clean interface between the silicon and HfO is provided by the present invention. The oxide layer is preferably only one, or one half an atomic layer. Such control provided by the present invention is a very powerful technique. While a specific example has been illustrated with hafnium, the method of the present invention may deposit many other metal oxide layers, including layers comprising metals from the following: Ti, Zr, Y, La, C, Nb, Ta, W, Zn, Al, Sn, Ce, Pr, Sm, Eu, Tb, Dy, Ho, Er, Tm, Yb or Lu.

A further embodiment of the invention involves energy-assisted atomic layer removal. In this case, a substrate with a film to be removed at an atomic scale is placed in a reactor at low temperature and high vacuum. A gas is introduced into the reaction chamber. A pulse of electromagnetic irradiation is initiated and excites the gas above the surface of the substrate to form radicals. As described above, any form of electromagnetic irradiation can be used as long as the electromagnetic irradiation is imposed as a pulse. Examples of suitable electromagnetic radiation include, but are not limited to, visible light radiation, infrared radiation, ultraviolet radiation, microwave radiation, radio frequency radiation, and the like. Again, radiation may be supplied in a coherent form from a device such as a laser, or in an incoherent form from a device such as a lamp. The selection of electromagnetic irradiation depends on the application and the type of film to be removed. While microwave energy may create an electrical field across the substrate; visible, infrared and ultraviolet radiation and the like do not create electrical field and thus are preferable for applications where electrical field should be avoided. The electromagnetic irradiation can be imposed from the top of the reactor to a particular local area above the substrate. Alternatively, in a multiple wafer reactor, a side wall scanning source can be used to impose electromagnetic irradiation to the multiple substrates sequentially. In another embodiment, a focused source of electromagnetic radiation can be used to activate the reactions at selected areas of the substrate, creating a “direct write” removal process. The radical species react with the surface to form volatile compounds which are removed from the reaction chamber. The process can be repeated to remove atomic layers of films, as desired.

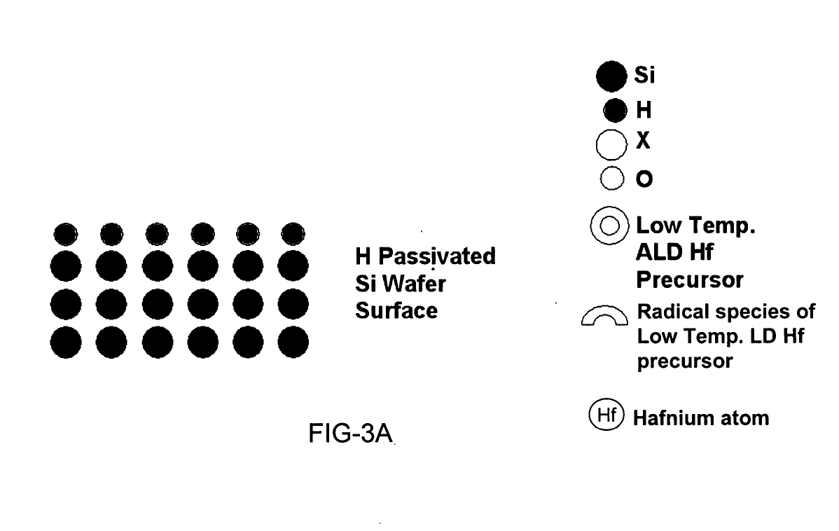

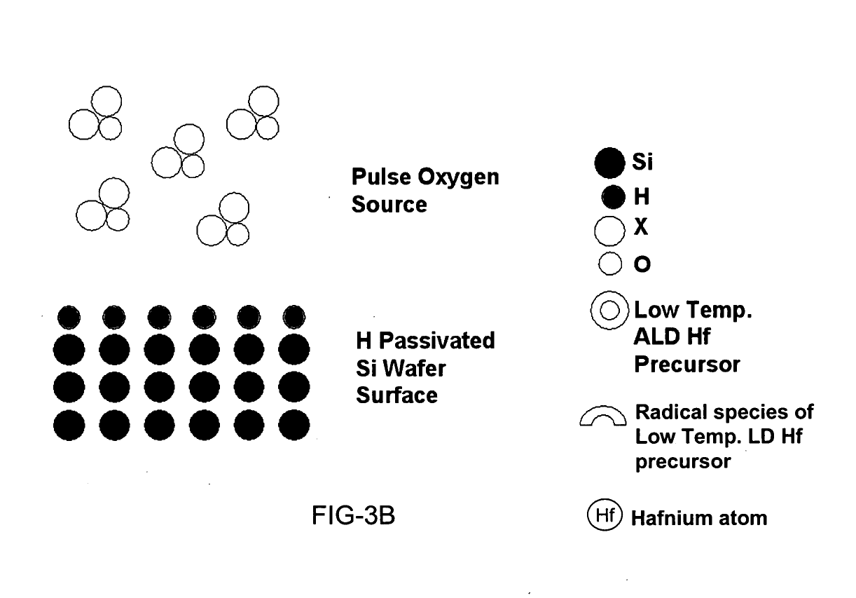

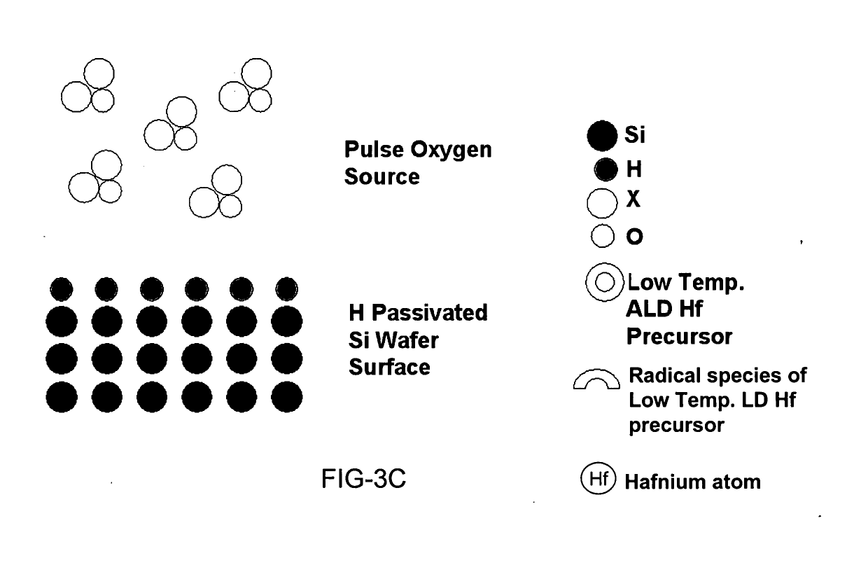

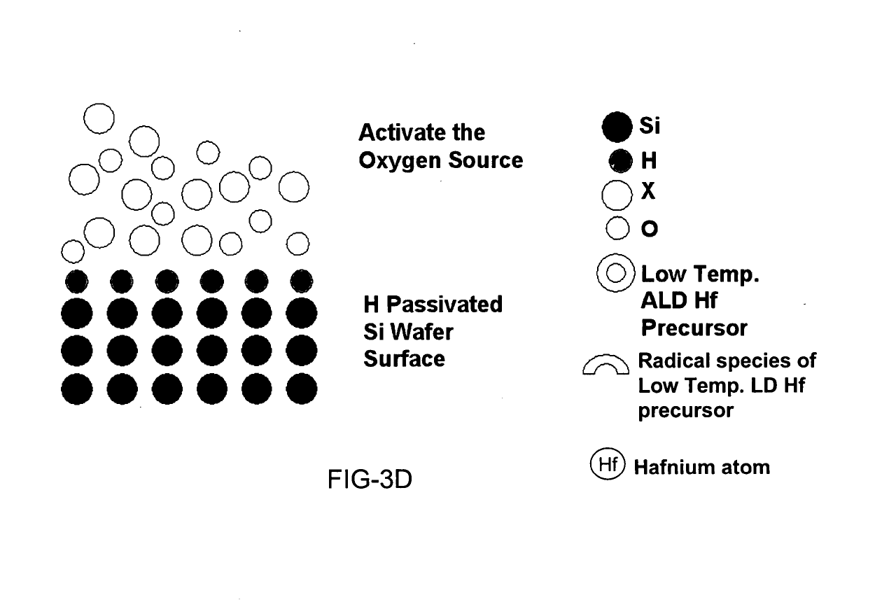

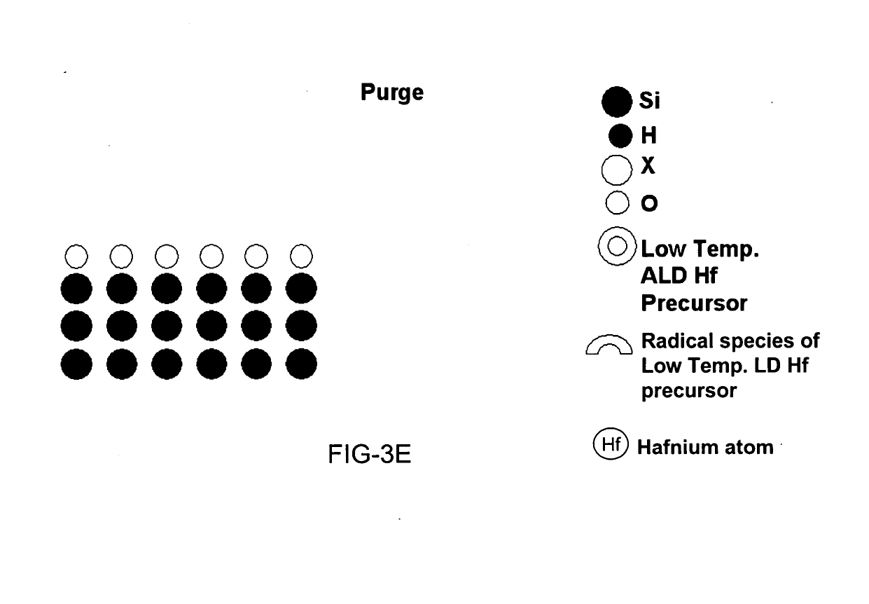

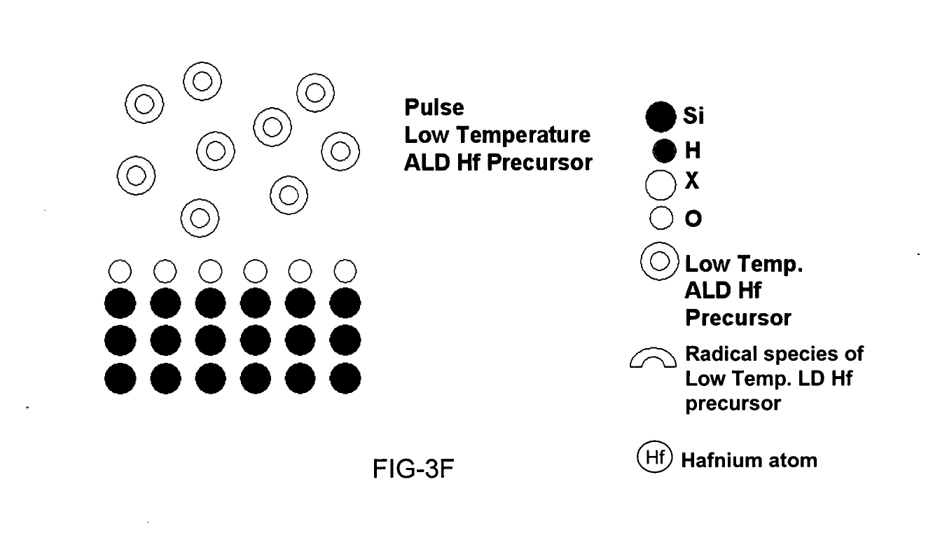

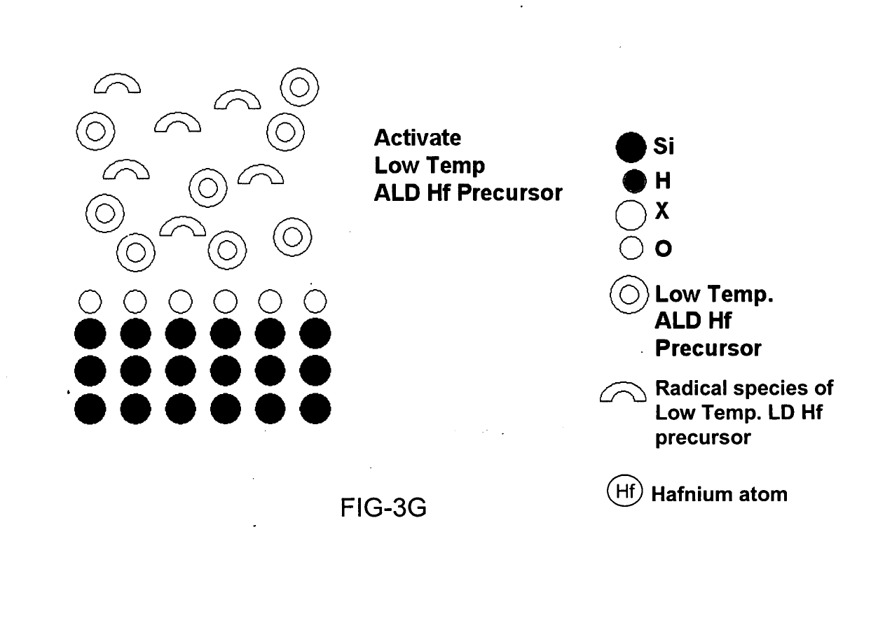

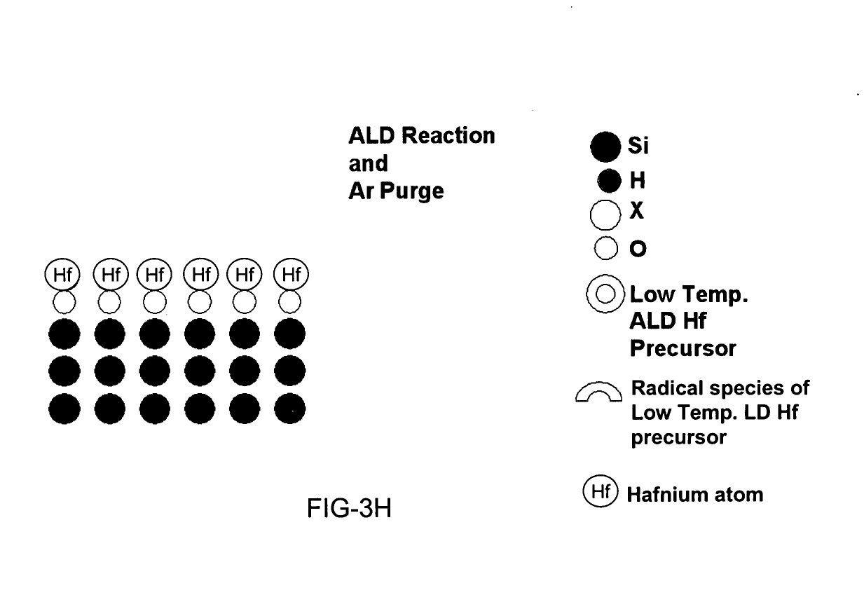

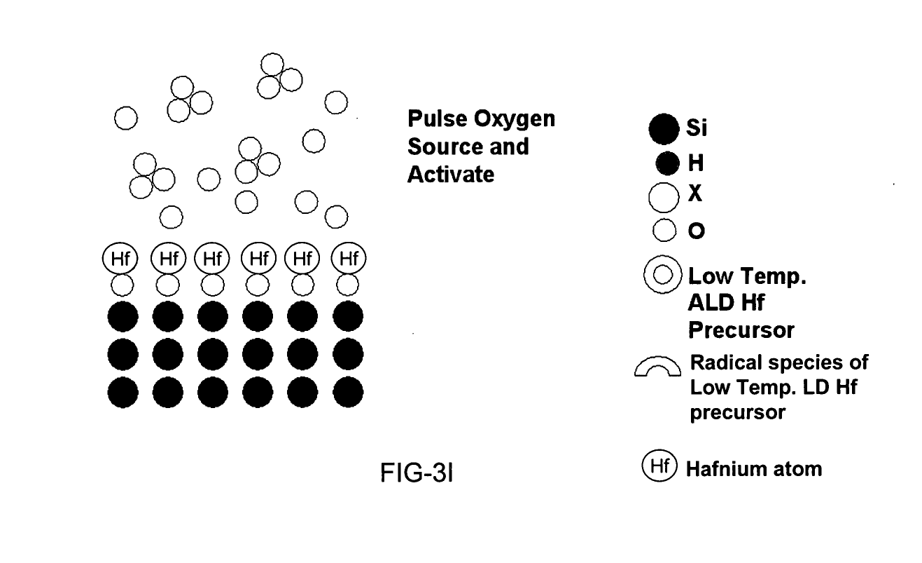

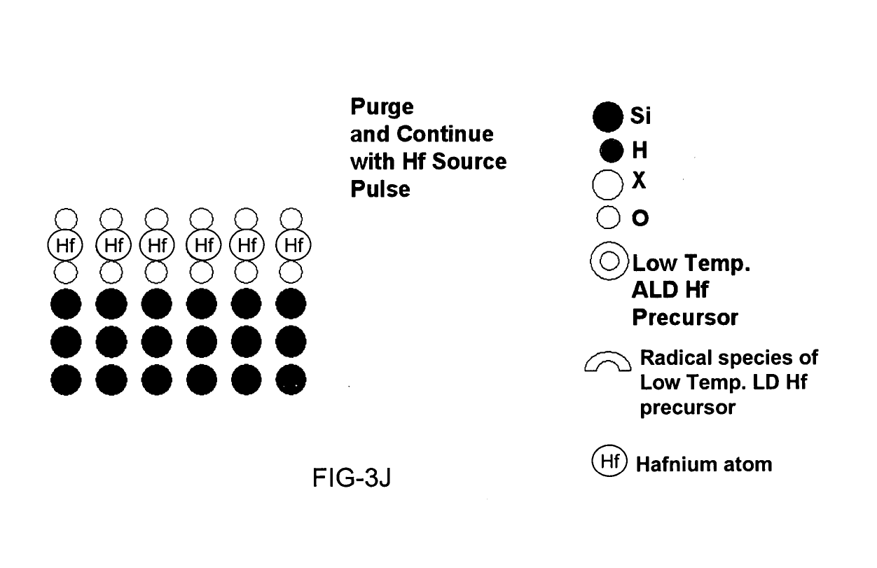

Another exemplary embodiment of the method of the present invention is illustrated in FIGS. 3A to 3J which show sequential steps in detail. In this example atomic layer exchange is carried out with energy-assistance to form a gate dielectric having an equivalent oxide thickness (EOT) of 5 Å. Atomic layer exchange is carried out to modify the chemistry of the film surface. As show in FIG. 3A, a silicon wafer having a hydrogen-terminated surface is provided. Next, an oxygen source is conveyed to the reaction chamber about the wafer. The oxygen source is activated by electromagnetic radiation as shown in FIG. 3C. The activated oxygen source undergoes a surface reaction with the wafer and exchanges hydrogen atoms with oxygen atoms to form one, or one half, atomic layer of oxide on the wafer as shown in FIG. 3D. The reaction chamber is then purged.

Next, a precursor which upon reaction with the substrate will produce the desired gate dielectric material, is conveyed to the chamber. In this example, a Hf containing source is the precursor. Alternatively, the precursor may contain a metal source from the group of Ti, Zr, Y, La, C, Nb, Ta, W, Zn, Al, Sn, Ce, Pr, Sm, Eu, Tb, Dy, Ho, Er, Tm, Yb or Lu, to produce a different, respective metal oxide. The metal containing precursor is activated by a pulse of electromagnetic radiation, such as a UV energy pulse, at low temperature (as recited above) and as shown in FIGS. 3F and 3G. Atomic layer deposition occurs on the surface of the wafer as shown in FIG. 3H, and then the reaction chamber is purged, preferably with the assistance of an inert gas, such as argon and the like.

To form the dielectric, in this example hafliium oxide, an oxygen source is again conveyed to the reactor as shown in FIG. 31. The oxygen source is activated by a energy pulse, and atomic layer deposition occurs to form a HfD₂ layer on the surface of the wafer. The oxygen source is purged (FIG. 3J) from the reaction chamber and the process may be repeated to form additional atomic layers as desired.

As described above, atomic layer exchange takes place between free radicals or molecules in the gas phase and the wafer surface. Diffusion of these gaseous precursors through the wafer surface may be controlled by a number of parameters, including temperature, pulse time, chamber pressure, molecule size and reactivity to avoid multilayer atomic exchange.

The energy-assisted atomic layer deposition and removal method of the present invention has broad applications. For example, the present invention can be used to etch metals and dielectrics, generate lithographic masks, and improve the resolution of liquid crystal displays, among other applications. High quality high-k dielectric films can be deposited with selected ALD precursors at low deposition temperature with energy activation. The silicon-high-k dielectric interface may be controlled by atomic layer exchange of the present invention along with low temperature ALD high-k dielectric processes.

In another aspect of the present invention, a method and system for deposition of atomic layers on semiconductors low temperature and in a vacuum environment is provided. In general the present invention provides an ALD method and system where a film is deposited on a substrate at room, or near room, temperature, often referred to as ambient temperature, and is generally in the range of approximately 20 to 30° C. Generally, the method comprising the steps of: placing a substrate into a vacuum reaction chamber and introducing a reactant gas, or combination of gasses, into the chamber to react with the substrate (a silicon surface or a layer of the ALD film) to convert the layer into a mono-layer of a solid compound. Excess reactant gas or gasses are purged from the reaction chamber. Once the chamber is evacuated of gases, the mono-layer on the substrate is irradiated with vacuum UV (VUV) radiation. Optionally, an oxidant gas can be introduced into the reactor. Following the radiation step, excess gas is again purged from the chamber, and the cycle is repeated as many times as needed to form the desired film.

When the energy pulse is initiated, the lamp is turned on, or a shutter (if present) is opened irradiating the chamber and the surface of the substrate. Preferably, the duration of the irradiation is in the range of approximately 0.1 seconds to 10 seconds. During processing, the pressure in reaction chamber is held at vacuum, preferably at a pressure in the range of approximately 1×10⁻⁸ to 10 torr. After irradiation, the chamber is again purged to evacuate any excess reactant gas. This cycle can be repeated as necessary with the same or different reactant gasses, depending upon the application and desired device. Typically, the cycle is repeated 10 to several hundred times. During subsequent cycles the duration of the irradiation, the wavelength of the irradiation, and the strength of the vacuum can all be varied according to the needs of the specific application. The selection of the these variables depend on the nature of the reactant gases and the chemical bonds involved in the deposition, and can be determined by one of ordinary skill in the art with routine experimentation.

One application of the present invention provides for the deposition of a high dielectric constant (high-k) metal oxides onto a silicon substrate. Of particular advantage to this application is that the deposition is performed at lower temperatures thereby suppressing the formation of interfacial oxide growth between dielectric and silicon surface. The method of the present invention can be performed at a temperature in the range of about room temperature to 200° C., preferably at room temperature.

For example, oxygen containing metal-organic complex, such as Hf(t-BuO)₄, Zr(t-BuO)₄ and the like, can be used as precursors for depositing HfO₂ and ZrO₂ onto a silicon substrate. The reaction can optionally include oxidant gases and proceeds at low temperature using the VUV-assisted ALD process of the present invention. The substrate can be of any type including a film deposited on a substrate as used in semiconductor processing such as any gate dielectric or ceramic, including metal oxides, aluminates, silicates, nitrides, or pure metals.

While the present invention is disclosed by reference to the preferred embodiments and examples detailed above, it is to be understood that these examples are intended in an illustrative rather than limiting sense, as it is contemplated that modifications and combinations will readily occur to those skilled in the art, which modifications and combinations will be within the scope of the invention and the scope of the appended claims.

1. A method of depositing a film on a substrate in a reaction chamber, comprising:
introducing a first gas into the reaction chamber;
initiating a first pulse of electromagnetic irradiation to form radicals species from said first gas, where the radical species react with the surface of the substrate to form a radical terminated surface on the substrate;
purging the reaction chamber;
introducing a second gas into the reactor; and
initiating a second pulse of electromagnetic irradiation to form second radicals species from said second gas, where the second radical species react with the radical terminated surface to form a layer of film on the substrate.

2. A method of removing a film on a substrate in a reaction chamber, comprising:
introducing a gas into the reaction chamber;
irradiating the gas with a first pulse of electromagnetic irradiation, forming radical species from said gas; and
reacting the radicals with the film on the surface of the substrate to form a volatile compound and thus removing an atomic layer of the film.

3. A method for depositing an atomic layer on a substrate in a reaction chamber comprising:
introducing reactant gas or gasses into the reaction chamber and reacting the reactant with the surface of the substrate to form an atomic layer on the surface of the substrate;
evacuating the reaction chamber; and
irradiating the surface of the substrate with ultra-violet radiation.

4. The method of claims 1, 2 or 3 further comprising:
pre-treating the substrate to condition the surface of the substrate.

5. The method of claims 1, 2 or 3 wherein said purging step comprises evacuating the reaction chamber, purging with an inert gas, or both.

6. The method of claim 1 further comprising:
purging the chamber after the step of initiating a second pulse of electromagnetic irradiation; and
repeating the steps to form a desired film.

7. The method of claims 1 or 2 wherein the method is carried out at a temperature in the range of approximately 20 to 400° C.

8. The method of claims 1 or 2 wherein the method is carried out at a temperature in the range of approximately 100 to 200° C.

9. The method of claims 1, 2 or 3 wherein the method is carried out at a temperature in the range of approximately 20 to 30° C.

10. The method of claims 1 or 2 wherein the electromagnetic irradiation is comprised of visible light radiation, infrared radiation, ultraviolet radiation, microwave radiation, radio frequency radiation or vacuum ultraviolet radiation.

11. The method of claims 1 or 2 wherein the introducing and initiating steps are carried out at a pressure in the range of approximately 1 mTorr to 760 Torr.

12. The method of claims 1 or 2 wherein the introducing and initiating steps are carried out at a pressure in the range of less that approximately 150 Torr.

13. The method of claims 1 or 2 wherein the introducing and initiating steps are carried out at a pressure in the range of less than approximately 15 Torr.

14. The method of claim 3 wherein the method is carried out in a vacuum and at a temperature in the range of approximately 20 to 30° C.

15. The method of claim 3 further comprising
purging the chamber following the irradiating step and,
repeating the steps a plurality of times with the same or different reactant gasses.
